(19) United States
(12) Patent Application Publication
(10) Pub. No.: US 2015/0246617 A1
(43) Pub. Date: Sep. 3, 2015

(54) POWER RECEIVING DEVICE, POWER TRANSMITTING DEVICE, AND ELECTRIC VEHICLE

(71) Applicant: Kabushiki Kaisha Toshiba, Minato-ku (JP)

(72) Inventors: Tetsu SHIJO, Setagaya (JP); Akiko Yamada, Yokohama (JP); Shuichi Obayashi, Yokohama (JP)

(73) Assignee: Kabushiki Kaisha Toshiba, Minato-ku (JP)

(21) Appl. No.: 14/715,063

(22) Filed: May 18, 2015

Related U.S. Application Data
(63) Continuation of application No. PCT/JP2013/078248, filed on Oct. 10, 2013.

(30) Foreign Application Priority Data
Nov. 20, 2012 (JP) 2012-254450

(51) Int. Cl. B60L 11/18; H02J 5/00

(52) U.S. Cl. CPC B60L 11/182; H02J 5/005

(57) ABSTRACT

In one embodiment, a power receiving device includes a power receiving inductor wirelessly receiving electric power from a power transmitting device, a capacitor unit connected to the power receiving inductor, a communication unit exchanging a power transmission status or a power reception status with the power transmitting device, a sensor unit performing at least one of received power detection, foreign object detection, and temperature detection, and a control unit controlling received power based on information received by the communication unit or a result of the detection performed by the sensor unit. The power receiving inductor includes a magnetic core, a coil winding, and a conductor plate. The magnetic core is provided in a detachable unit detachably attached to a housing of the power receiving device. The sensor unit is provided outside the detachable unit.

### CROSS REFERENCE TO RELATED APPLICATION(S)

This application is a continuation of International application No. PCT/JP2013/078248, filed on Oct. 10, 2013, the entire contents of which is hereby incorporated by reference, the international application No. PCT/JP2013/078248 claiming the benefit of priority from the prior Japanese Patent Application No. 2012-254450, filed on Nov. 20, 2012.

### FIELD

The present invention relates to a power receiving device, a power transmitting device, and an electric vehicle.

### BACKGROUND

In recent years, the wireless power transmission technique for wirelessly transmitting electric power through mutual inductance between a power receiving inductor and a power transmitting inductor in a non-contact manner has been used in many apparatuses. For example, wirelessly-transmitted electric power is used to charge an electric apparatus connected to a power receiving device. The power receiving inductor provided in the power receiving device includes a magnetic core, a coil winding portion, and a conductor plate and is heavy in weight.

### BRIEF DESCRIPTION OF THE DRAWINGS

FIG. 1 is a block configuration diagram of a wireless power transmission system according to a first embodiment;

FIG. 2 is a vertical cross-sectional view of a power receiving device according to the first embodiment;

FIG. 3 is a top view of the power receiving device according to the first embodiment;

FIG. 4 is a diagram showing an example structure of a capacitor unit;

FIG. 5 is a block configuration diagram of a wireless power transmission system according to a second embodiment;

FIG. 6 is a block configuration diagram of a wireless power transmission system according to a third embodiment;

FIG. 7 is a block configuration diagram of a wireless power transmission system according to a fourth embodiment;

FIG. 8 is a vertical cross-sectional view of a power receiving device according to a first modification;

FIG. 9 is a vertical cross-sectional view of another power receiving device according to the first modification;

FIG. 10 is a vertical cross-sectional view of yet another power receiving device according to the first modification;

FIG. 11 is a vertical cross-sectional view of a power receiving device according to a second modification;

FIG. 12 is a vertical cross-sectional view of a power receiving device according to a third modification;

FIG. 13 is a top view of the power receiving device according to the third modification; and

FIG. 14 is a diagram showing an electric vehicle to which a wireless power transmission system is applied.

### DETAILED DESCRIPTION OF THE INVENTION

The object of the present invention is to provide a power receiving device in which a magnetic core of a power receiving inductor is detachably provided and a connector for a detachable unit has a simple structure, and to provide an electric vehicle including such a power receiving device.

In one embodiment, a power receiving device includes a power receiving inductor wirelessly receiving electric power from a power transmitting device, a capacitor unit connected to the power receiving inductor, a communication unit exchanging a power transmission status or a power reception status with the power transmitting device, a sensor unit performing at least one of received power detection, foreign object detection, and temperature detection, and a control unit controlling received power based on information received by the communication unit or a result of the detection performed by the sensor unit. The power receiving inductor includes a magnetic core, a coil winding, and a conductor plate. The magnetic core is provided in a detachable unit detachably attached to a housing of the power receiving device. The sensor unit is provided outside the detachable unit.

Hereinafter, embodiments of the present invention will be described with reference to the accompanying drawings.

### First Embodiment

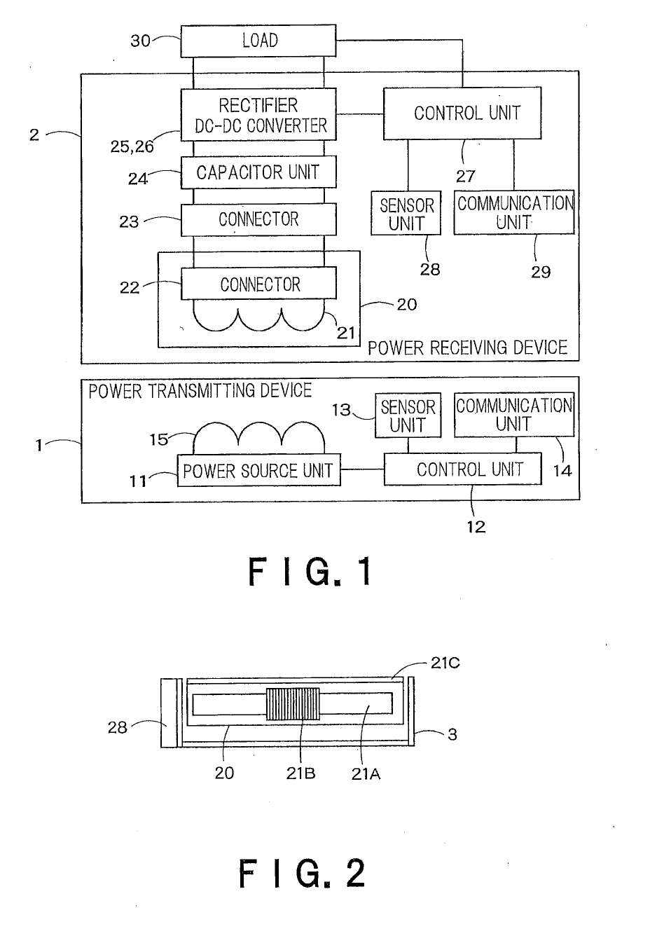

FIG. 1 shows the block configuration of a wireless power transmission system according to a first embodiment of the present invention. The wireless power transmission system includes a power transmitting device 1 and a power receiving device 2 to which electric power is wirelessly transmitted from the power transmitting device 1. The power receiving device 2 supplies the transmitted power to a load 30 of an electric apparatus. The power receiving device 2 may be provided in the electric apparatus, may be formed integrally with the electric apparatus, or may be fixed to the exterior of the main body of the electric apparatus. The electric apparatus may be a mobile terminal or an electric vehicle, and the load 30 may be a rechargeable battery, for example.

The power transmitting device 1 includes a power source unit 11 that converts commercial power into RF for power transmission, a control unit 12 that controls the required amount of power and controls the respective components of the power transmitting device 1, a sensor unit 13, a communication unit 14, and a power transmitting inductor 15. The sensor unit 13 includes at least one of a temperature sensor that monitors heat generation in the power transmitting device 1, a temperature sensor that monitors the heat of foreign object that exists between the power transmitting inductor 15 and a later-described power receiving inductor 21, a sensor that monitors foreign object with an electromagnetic radar or an ultrasonic radar, a sensor such as an RFID for detecting the position of the power receiving inductor 21, and a sensor that is formed with an ammeter or a voltmeter for detecting transmitted power and is to be used for wireless power transmission between the power transmitting device 1 and the power receiving device 2, for example. The communication unit 14 can communicate with a later-described communication unit 29 of the power receiving device 2, and receives a power reception status of the power receiving device 2 or transmits a power transmission status of the power transmitting device 1.

The power receiving device 2 includes a power receiving inductor 21 that receives electric power through mutual inductance between the power transmitting inductor 15 of the power transmitting device 1 and the power receiving inductor 21, a capacitor unit 24 connected to the power receiving inductor 21 via later-described connectors 22 and 23, a rectifier 25 that converts AC power received via the capacitor unit 24 into DC power, a DC-DC converter 26 that changes a voltage conversion ratio based on the operating voltage of the load 30, a control unit 27 that controls the respective components of the power receiving device 2, a sensor unit 28, and the communication unit 29. When the received electric power is controlled in the power transmitting device 1, the DC-DC converter 26 can be omitted.

The capacitor unit 24 may be connected in series to the power receiving inductor 21, or may be connected in parallel to the power receiving inductor 21. As shown in FIG. 4, the capacitor unit 24 may include a capacitor element connected in parallel to the power receiving inductor 21 and a capacitor element connected in series to the power receiving inductor 21.

The sensor unit 28 includes at least one of a temperature sensor that monitors heat generation in the power receiving device 2, a temperature sensor that monitors the heat of foreign object that exists between the power receiving inductor 21 and the power transmitting inductor 15, a sensor that monitors foreign object with an electromagnetic radar or an ultrasonic radar, a sensor such as an RFID for detecting the position of the power transmitting inductor 15, and a sensor that is formed with an ammeter or a voltmeter for detecting received power and is to be used for wireless power transmission between the power transmitting device 1 and the power receiving device 2, for example. The communication unit 29 can communicate with the communication unit 14 of the power transmitting device 1, and transmits a power reception status of the power receiving device 2 or receives a power transmission status of the power transmitting device 1.

The control unit 27 controls the received power (a power supply to the load 30) based on information acquired by communication of the communication unit 29 with the power transmitting device 1 and a result of detection performed by the sensor unit 28.

The power receiving device 2 includes a detachable unit 20 that can be detached from the housing 3 of the power receiving device 2. When the power receiving device 2 is formed integrally with an electric apparatus, the housing 3 also serves as the housing of the electric apparatus.

The power receiving inductor 21 is placed in the detachable unit 20. The connector 22 is placed in the detachable unit 20, while the connector 23 is placed in the housing 3. When the detachable unit 20 is detached from the housing 3, the connector 22 and the connector 23 are disconnected from each other. When the detachable unit 20 is attached to the housing 3, the connector 22 and the connector 23 are connected to each other, and the power receiving inductor 21 is connected to the capacitor unit 24 via the connectors 22 and 23.

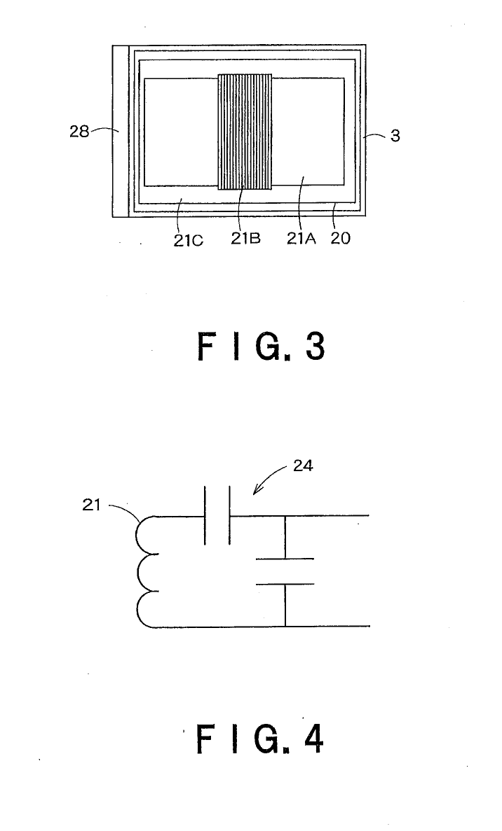

FIG. 2 is a vertical cross-sectional view of the power receiving device 2. FIG. 3 is a top view of the power receiving device 2. As shown in FIGS. 2 and 3, the power receiving inductor 21 placed in the detachable unit 20 includes a magnetic core 21A, a coil winding portion 21B wound around the magnetic core 21A, and a conductor plate 21C. The coil winding portion 21B of the power receiving inductor 21 is connected to the capacitor unit 24 via the connectors 22 and 23. The conductor plate 21C is a metal plate such as an aluminum plate or a copper plate. The detachable unit 20 may be surrounded by a dielectric material.

In FIG. 2, the conductor plate 21C is located above the magnetic core 21A and the coil winding portion 21B. In FIG. 3, however, the magnetic core 21A and the coil winding portion 21B appear to be located above the conductor plate 21C, for convenience of explanation.

In this embodiment, the power receiving inductor 21 including the magnetic core 21A and the conductor plate 21C, which are heavy in weight, is placed in the detachable unit 20, so that the power receiving inductor 21 can be detached from the power receiving device 2. Accordingly, when wireless power transmission is not performed, or after charging is completed, the detachable unit 20 is detached from the power receiving device 2, so that the electric apparatus in which the power receiving device 2 is provided can become lighter in weight.

Meanwhile, the sensor unit 28, which is light in weight, is not placed in the detachable unit 20, but is left in the power receiving device 2 after the detachable unit 20 is detached from the power receiving device 2. Accordingly, the connectors 22 and 23 between the detachable unit 20 and the power receiving device 2 simply have to connect the power receiving inductor 21 (or the coil winding portion 21B) to the capacitor unit 24, and there is no need to prepare any connecting unit for the sensor unit 28. Thus, the structure can be simplified.

In the above-described embodiment, all the sensors in the sensor unit 28 are not placed in the detachable unit 20, and are left in the power receiving device 2 after detachment of the detachable unit 20. However, while at least one of the sensors to be used for wireless power transmission between the power transmitting device 1 and the power receiving device 2 is left in the power receiving device 2, one or more of the sensors included in the sensor unit 28 may be placed in the detachable unit 20. With this arrangement, the electric apparatus in which the power receiving device 2 is provided can be made even lighter in weight after detachment of the detachable unit 20, though the connector structure between the detachable unit 20 and the power receiving device 2 becomes more complicated. Which sensor is to be placed in the detachable unit 20 is preferably determined by taking into consideration the complicated connector structure and the weight reduction of the power receiving device 2 by virtue of detachment of the detachable unit 20.

### Second Embodiment

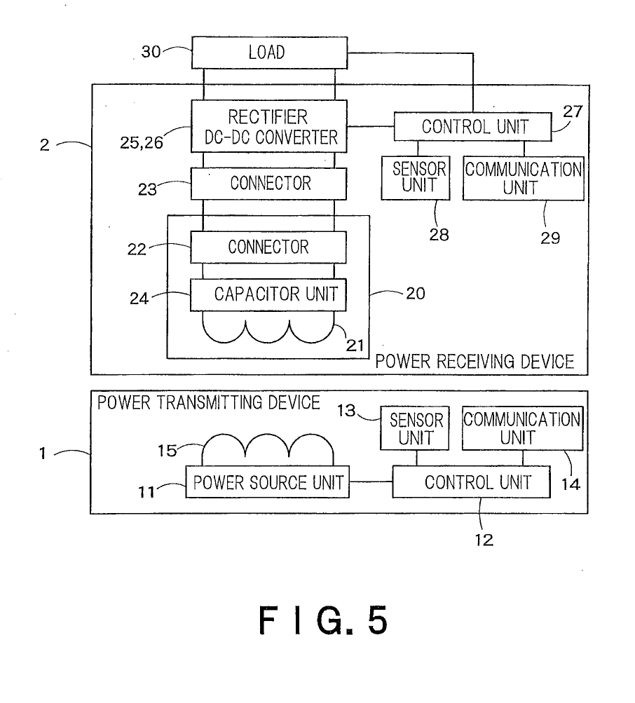

FIG. 5 shows the block configuration of a wireless power transmission system according to a second embodiment of the present invention. This embodiment differs from the first embodiment illustrated in FIG. 1 in that the capacitor unit 24 is placed in the detachable unit 20. In FIG. 5, the same components as those in the first embodiment shown in FIG. 1 are denoted by the same reference numerals as those used in FIG. 1, and explanation of them is not repeated herein.

As shown in FIG. 5, the capacitor unit 24 placed in the detachable unit 20 is connected to the rectifier 25 and the DC-DC converter 26 via the connectors 22 and 23. With this arrangement, the voltage at the connectors 22 and 23 can be lowered when the capacitor of the capacitor unit 24 is connected in series to the power receiving inductor 21. Also, the current flowing in the connectors 22 and 23 can be reduced when the capacitor of the capacitor unit 24 is connected in parallel to the power receiving inductor 21. In view of this, the rated voltage or the rated current of the connectors 22 and 23 can be lowered.

### Third Embodiment

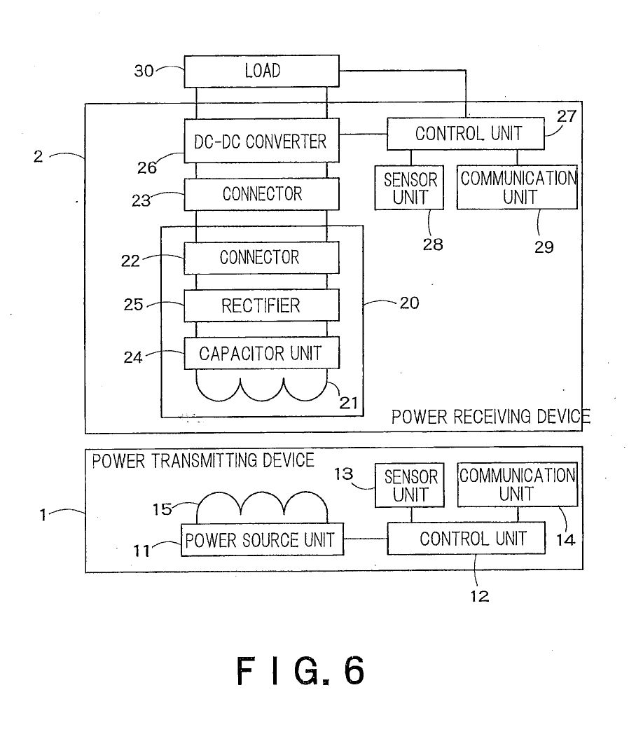

FIG. 6 shows the block configuration of a wireless power transmission system according to a third embodiment of the present invention. This embodiment differs from the second embodiment illustrated in FIG. 5 in that the rectifier 25 is placed in the detachable unit 20. In FIG. 6, the same components as those in the second embodiment shown in FIG. 5 are denoted by the same reference numerals as those used in FIG. 5, and explanation of them is not repeated herein.

As shown in FIG. 6, the rectifier 25 placed in the detachable unit 20 is connected to the DC-DC converter 26 via the connectors 22 and 23. With this arrangement, the current flowing in the connectors 22 and 23 can be direct current. Accordingly, the parasitic capacitance of the connector unit and the influence of the inductance in the wiring from the connector 23 to the DC-DC converter 26 can be reduced.

### Fourth Embodiment

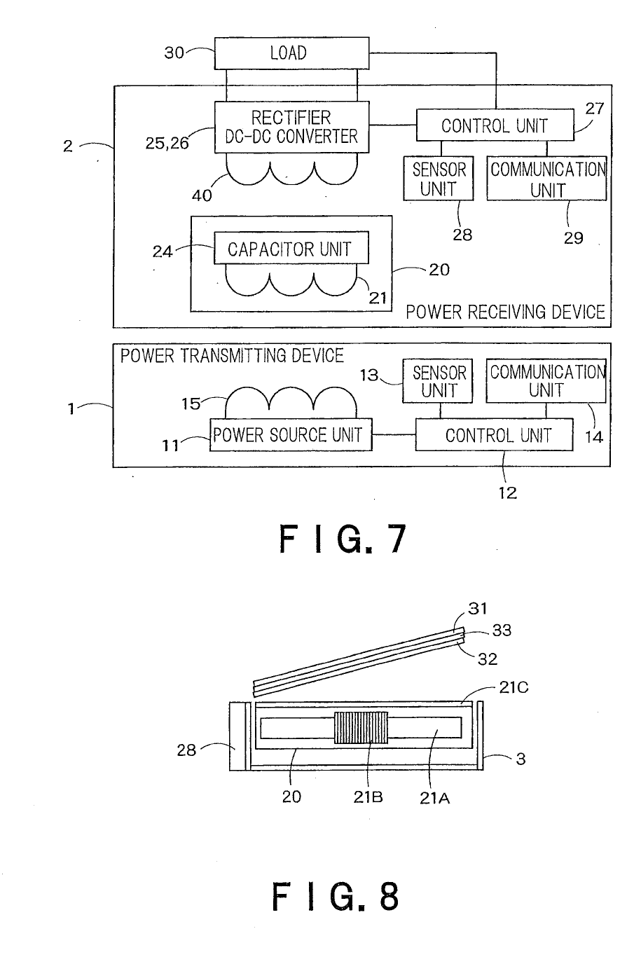

FIG. 7 shows the block configuration of a wireless power transmission system according to a fourth embodiment of the present invention. This embodiment differs from the first embodiment illustrated in FIG. 1 in that the connectors 22 and 23 pre not provided, the capacitor unit 24 is placed in the detachable unit 20, and a second power receiving inductor 40 is further provided. In FIG. 7, the same components as those in the first embodiment shown in FIG. 1 are denoted by the same reference numerals as those used in FIG. 1, and explanation of them is not repeated herein.

The second power receiving inductor 40 is placed outside the detachable unit 20, and is connected to the rectifier 25 and the DC-DC converter 26. In this embodiment, after electric power is transmitted between the power transmitting inductor 15 and the power receiving inductor (a first power receiving inductor) 21, electric power is transmitted to the rectifier 25 by virtue of a mutual coupling between the first power receiving inductor 21 and the second power receiving inductor 40.

By detaching the detachable unit 20 from the power receiving device 2, the electric apparatus in which the power receiving device 2 is provided can be made lighter in weight. Also, as electric power is wirelessly transmitted between the first power receiving inductor 21 and the second power receiving inductor 40, there is no need to provide a connector in the detachable unit 20 of the power receiving device 2.

### First Modification

FIG. 8 shows a first modification of the power receiving device 2. The power receiving inductor 21 placed in the detachable unit 20 generates heat at the time of power transmission. Therefore, a heat dissipation structure 32 is attached to the lid 31 of the housing 3, so that the heat can be dissipated via the heat dissipation structure 32. Also, a heat insulating mechanism 33 may be provided between the lid 31 and the heat dissipation structure 32, so as to prevent the lid 31 from having a temperature rise.

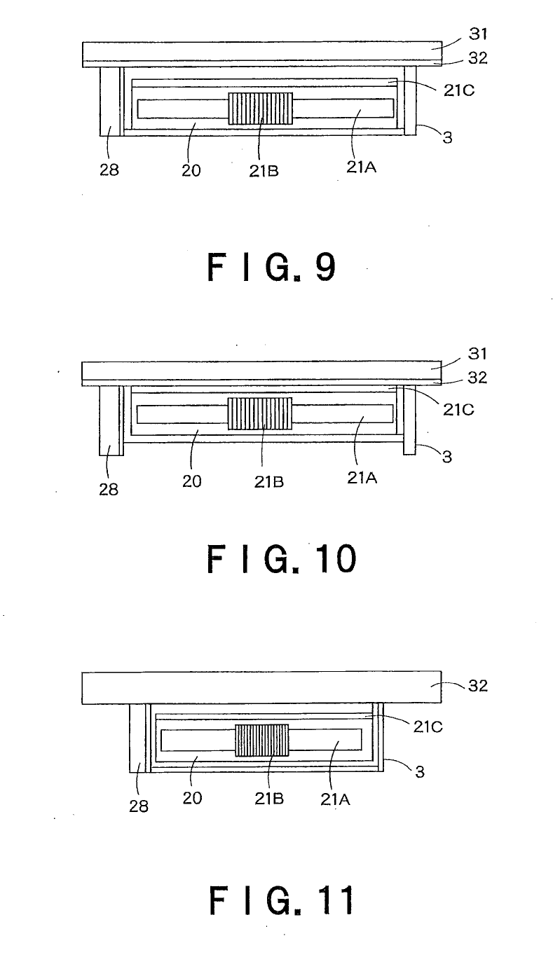

As shown in FIG. 9, the heat dissipation structure 32 may be attached to the lid 31, or, as shown in FIG. 10, heat may be dissipated from the heat dissipation structure 32 of the electric apparatus. Also, the detachable unit 20 may be pressed against the heat dissipation structure 32, to improve heat dissipation properties.

The conductor plate 21C may be attached to the housing 3 or to the lid 31. The conductor plate 21C is lighter in weight than the magnetic core 21A. Accordingly, when the detachable unit 20 including the magnetic core 21A is detached, the electric apparatus in which the power receiving device 2 is provided becomes sufficiently lighter in weight.

### Second Modification

FIG. 11 shows a second modification of the power receiving device 2. The heat dissipation structure 32 is secured to the housing 3, and the detachable unit 20 may be made to slide through a side of the housing 3 (from front to back in the drawing) when being attached or detached.

### Third Modification

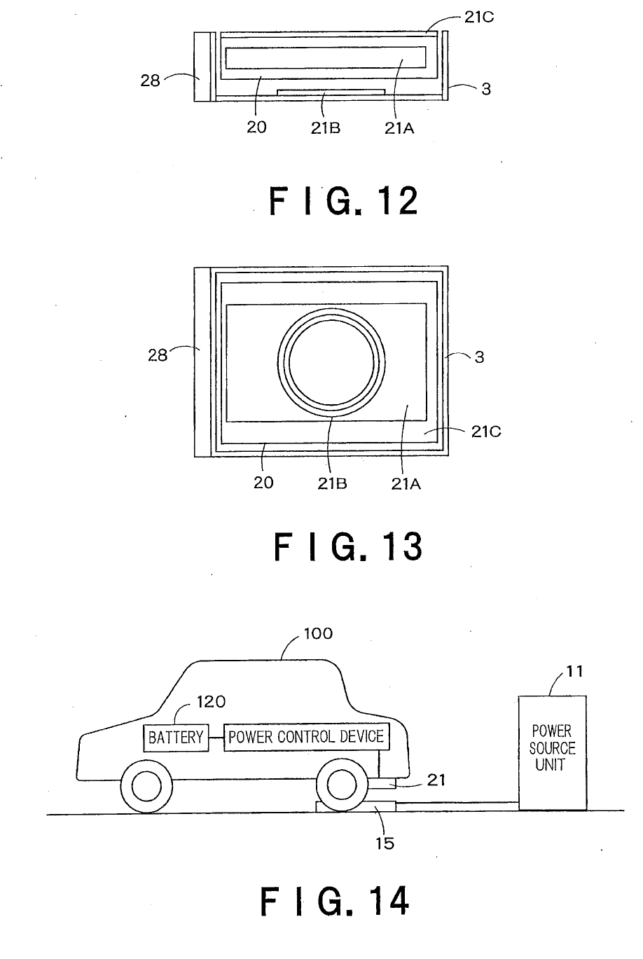

FIGS. 12 and 13 show a third modification of the power receiving device 2. FIG. 12 is a cross-sectional view, and FIG. 13 is a top view. As shown in FIGS. 12 and 13, the coil winding portion 21B may not be wound around the magnetic core 21A, and may be provided as a spiral coil on the housing 3 (outside the detachable unit 20). The coil winding portion 21B is lighter in weight than the magnetic core 21A. Accordingly, when the detachable unit 20 including the magnetic core 21A is detached, the electric apparatus in which the power receiving device 2 is provided becomes sufficiently lighter in weight.

In FIG. 13, the magnetic core 21A appears to be located above the conductor plate 21C, and the coil winding portion 21B appears to be located above the magnetic core 21A, for convenience of explanation.

FIG. 14 shows an example case where a wireless power transmission system according to one of the above embodiments is used in an electric vehicle 100. The power receiving device 2 is provided in the electric vehicle 100 as an electric apparatus. Electric power is transmitted from the power transmitting inductor 15 connected to the power source unit 11 to the power receiving inductor 21 via mutual inductance, and a battery 120 is charged via a power control device (formed with the rectifier 25, the DC-DC converter 26, the control unit 27, and the like).

The detachable unit 20 including the power receiving inductor 21 may be pulled out from below the body of the electric vehicle 100, or may be pulled out from inside the electric vehicle 100. When the detachable unit 20 is pulled out from inside the electric vehicle 100, the detachable unit 20 can be detached from the bottom portion of the trunk. In that case, a spare tire may be placed in the space from which the detachable unit 20 has been removed.

The sensor unit 28 of the power receiving device 2 may be housed in the housing of the power receiving device 2, or may be attached to the body of the electric vehicle 100.

Also, a moving mechanism that automatically moves the detachable unit 20 may be provided in the power receiving device 2, and the moving mechanism may perform accurate positioning of the detachable unit 20 attached by a user, or connect the connectors 22 and 23 to each other. When wireless power transmission is not performed, or after charging is completed, for example, the detachable unit 20 may be moved to a position where a user can easily pull out the detachable unit 20.

In the above-described embodiments, the power receiving inductor 21 of the power receiving device 2 is placed in the detachable unit 20, so that the power receiving inductor 21 can be detached from the housing 3 of the power receiving device 2. However, the power transmitting inductor 15 of the power transmitting device 1 may be made detachable from the housing of the power transmitting device 1. For example, a transmission-side detachable unit having the same structure as the detachable unit 20 is provided in the power transmitting device 1, and the power transmitting inductor 15 is housed in the transmission-side detachable unit. At this point, only the magnetic core of the power transmitting inductor 15 may be housed in the transmission-side detachable unit, or the other members such as the coil winding portion may also be housed in the transmission-side detachable unit.

The power transmitting inductor 15 and the power source unit 11 are connected by a first connector provided in the transmission-side detachable unit and a second connector provided in the housing of the power transmitting device 1. When the transmission-side detachable unit is detached from the housing of the power transmitting device 1, the first connector and the second connector are disconnected from each other. When the transmission-side detachable unit is attached to the housing of the power transmitting device, the first connector and the second connector are connected to each other, and the power transmitting inductor 15 is connected to the power source unit 11 via the first connector and the second connector.

Accordingly, when wireless power transmission is not performed, or after charging is completed, for example, the weight of the power transmitting device 1 can be reduced by detaching the transmission-side detachable unit from the power transmitting device 1. Also, the sensor unit 13, which is light in weight, is not placed in the transmission-side detachable unit, and is left in the power transmitting device 1 after the transmission-side detachable unit is detached. Accordingly, the first connector and the second connector between the transmission-side detachable unit and the power transmitting device 1 simply have to connect the power transmitting inductor 15 to the power source unit 11, and there is no need to prepare a connecting unit for the sensor unit 13. Thus, the structure can be simplified.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A power receiving device comprising:
a power receiving inductor wirelessly receiving electric power from a power transmitting device through mutual inductance;
a capacitor unit connected to the power receiving inductor;
a rectifier converting AC power received via the capacitor unit into DC power;
a communication unit exchanging a power transmission status or a power reception status with the power transmitting device;
a sensor unit performing at least one of received power detection, foreign object detection, and temperature detection; and
a control unit controlling received power based on information received by the communication unit or a result of the detection performed by the sensor unit, wherein
the power receiving inductor includes a magnetic core, a coil winding, and a conductor plate,
the magnetic core is provided in a detachable unit detachably attached to a housing of the power receiving device, and
the sensor unit is provided outside the detachable unit.

2. The device according to claim 1, wherein at least one of the coil winding and the conductor plate is provided in the detachable unit.

3. The device according to claim 1, wherein the capacitor unit is provided in the detachable unit.

4. The device according to claim 3, wherein the rectifier is provided in the detachable unit.

5. The device according to claim 1, wherein a heat dissipation unit dissipating heat generated at the power receiving inductor at the time of power reception is attached to a lid of the housing.

6. The device according to claim 5, wherein a heat insulating unit is provided between the lid and the heat dissipation unit.

7. The device according to claim 1, further comprising a moving unit moving the detachable unit to a predetermined position.

8. A power receiving device comprising:
a first power receiving inductor wirelessly receiving electric power from a power transmitting device through first mutual inductance;
a capacitor unit connected to the first power receiving inductor;
a second power receiving inductor connected to the first power receiving inductor through second mutual inductance;
a rectifier converting AC power received via the second power receiving inductor into DC power;
a communication unit exchanging a power transmission status or a power reception status with the power transmitting device;
a sensor unit performing at least one of received power detection, foreign object detection, and temperature detection; and
a control unit controlling received power based on information received by the communication unit or a result of the detection performed by the sensor unit, wherein
the first power receiving inductor and the capacitor unit are provided in a detachable unit detachably attached to a housing of the power receiving device, and
the sensor unit is provided outside the detachable unit.

9. An electric vehicle comprising the power receiving device of claim 1.

10. The electric vehicle according to claim 9, wherein the detachable unit is detachable via a bottom portion of a trunk.

11. A power transmitting device comprising:
a power source unit supplying a high-frequency power source;
a power transmitting inductor wirelessly transmitting electric power from the power source unit to a power receiving device through mutual inductance;
a communication unit exchanging a power transmission status or a power reception status with the power receiving device;
a sensor unit performing at least one of transmitted power detection, foreign object detection, and temperature detection; and
a control unit controlling transmitted power based on information received by the communication unit or a result of the detection performed by the sensor unit, wherein
the power transmitting inductor includes a magnetic core,
the magnetic core is provided in a detachable unit detachably attached to a housing of the power transmitting device, and
the sensor unit is provided outside the detachable unit.
